(19) United States
(12) Patent Application Publication
(10) Pub. No.: US 2008/0226007 A1
(43) Pub. Date: Sep. 18, 2008

(54) METHOD AND APPARATUS FOR POWER ESTIMATION FOR TDSOFDM IN TRANSMISSION

(75) Inventors: Lin Yang, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/048,340

(22) Filed: Mar. 14, 2008

Related U.S. Application Data
(60) Provisional application No. 60/895,136, filed on Mar. 15, 2007.

(51) Int. Cl. H04L 7/00

(52) U.S. Cl. 375/367

(57) ABSTRACT

A method and apparatus for a receiver to estimate the received power for each transmitting BS. The power measure can be obtained by using some or all receiving antennas.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-034.

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-040.

U.S. patent application Ser. No. ______ with attorney docket number LSFFT-041.

### REFERENCE TO RELATED APPLICATIONS

This application claims an invention which was disclosed in Provisional Application No. 60/895,136, filed 15 Mar. 2007 entitled “METHOD AND APPARATUS FOR POWER ESTIMATION FOR TDS-OFDM IN TRANSMISSION”. The benefit under 35 USC §119(e) of the United States provisional application is hereby claimed, and the aforementioned application is hereby incorporated herein by reference.

### FIELD OF THE INVENTION

The present invention relates generally to TDS-OFDM system, more specifically the present invention relates to power estimation for a TDS-OFDM system in information transmission.

### BACKGROUND

TDS-OFDM has been successfully applied to digital TV applications including DMB-TH. Power estimation such as power control and hand-off is needed for a TDS-OFDM system.

Therefore, a system, device, or method is required for a power estimation in the above mentioned OFDM system.

### SUMMARY OF THE INVENTION

In a TDS-OFDM system, a method and apparatus is provided for a receiver to estimate the received power of a plurality of BSs using multiple antennas.

A method for estimating power level comprising the steps of: providing at least one PN sequence; transmitting the PN sequence; receiving the PN sequence; and estimating a received power based upon a parameter of the received PN sequence and at least one known value associated with the transmitted PN sequence.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example OFDM system in accordance with some embodiments of the invention.

FIG. 2 is an example OFDM guard interval (GI) in accordance with some embodiments of the invention.

FIG. 3 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to estimate the received power of a plurality of BSs using multiple antennas. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of estimate the received power of a plurality of BSs using multiple antennas described herein. The non-processor circuits may include, but are not limited to, a radio receiver, a radio transmitter, signal drivers, clock circuits, power source circuits, and user input devices. As such, these functions may be interpreted as steps of a method to perform estimate the received power of a plurality of BSs using multiple antennas. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

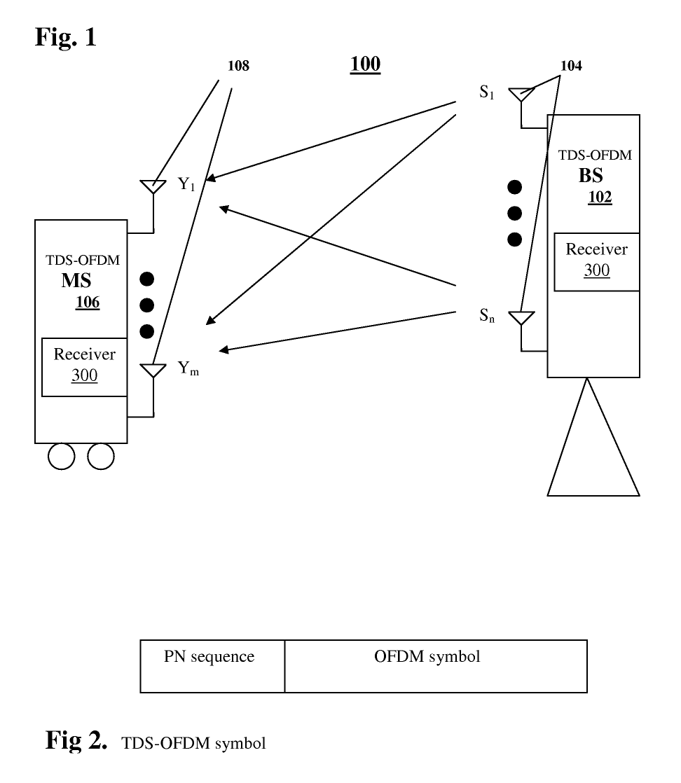

Referring to FIGS. 1-3, a plurality of base stations (BS) 102 (only one shown) each has two or more BS antennas 104. Each one of the antennas 104 respectively transmits signals S₁, S₂, . . . , Sₙ. At least one of the signals Sᵢ among the transmitted signals S₁, S₂, . . . , Sₙ uses the format shown in FIG. 2 employing a pseudo noise (PN) sequence Pᵢ as guard interval that may be among a plurality of PN acting as guard intervals interposed or inserted between data or symbols such as OFDM symbols. Mobile station (MS) 106 receives signals using multiple MS antennas 108. Each one of the antennas 108 is adapted to receive from all transmitted signals including the transmitted signals S₁, S₂, . . . , Sₙ from BS 102 as well as other base stations (not shown). Mobile station 106 comprises a receiver 300 for receiving signals from surrounding base stations. The receiver 300 in mobile station 106 is adapted such that all the PN sequences of substantially all the transmitted signals from substantially all the base stations including BS 102 in a predetermined neighborhood or geographic area are known to the base station 106. In other words, BS 102 and MS 106 know the PN sequences within a wireless communication neighborhood. This is advantageous in a TDS-OFDM system in that the guard intervals are the PN sequences. The receiver 300 is adapted to use the PN codes to perform a correlation in order to find a timing of each path. Both base station 102 and mobile station 106 comprise receivers 300.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

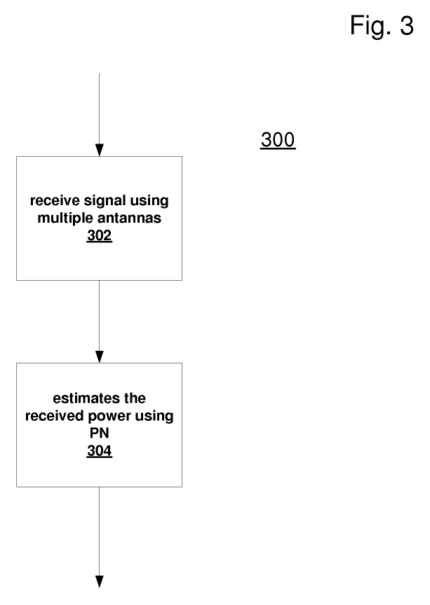

Referring specifically to FIG. 3, a flowchart 300 of the present invention is shown. Mobile station (MS) receives signals including PN sequences using multiple antennas (Step 302). Received signal at j-th antenna is Yⱼ. Received signal at j-th antenna Yⱼ receives signals from all transmitted signals S₁, S₂, . . . , Sₙ through multiple antennas. The receiver knows PN sequences of all transmitted signals from all neighboring BSs. The receiver or the MS may feedback power measures to BS. The receiver estimates the received power for each transmitting BS (Step 304). The power measure can be obtained by using some or all receiving antennas. One mean for estimating the received power is the compare the parameters of known PNs with the received PNs. If a received PN parameters or value fall below a threshold value, the signal strength is consider below par. Other means for estimating the received power includes predetermine a set of values for a received PN in relation to a known PN (known to the receiver) instead of a single threshold value.

As can be seen, base station (BS) transmits signals S₁, S₂, . . . , Sₙ through multiple antennas. Transmitted signal at i-th antenna Sᵢ uses the format in FIG. 2 employing PN sequence Pᵢ. A packet of transmission or a received packet having PN sequence as guard intervals is shown. The packet is positioned sequentially within a frame among a multiplicity of packets. As can be appreciated, PNs are disposed between the OFDM symbols acting as guard intervals.

Mobile station (MS) receives signals using multiple antennas. Received signal at j-th antenna is Yⱼ. Received signal at j-th antenna Yⱼ receives signals from all transmitted signals S₁, S₂, . . . , Sₙ through multiple antennas. The receiver knows PN sequences of all transmitted signals from all neighboring BSs. The receiver or the MS may feedback power measures to BS. The receiver can estimate the received power for each transmitting BS. The power measure can be obtained by using some or all receiving antennas.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for estimating power level comprising the steps of:
providing at least one PN sequence;
transmitting the PN sequence;
receiving the PN sequence; and
estimating a received power based upon a parameter of the received PN sequence and at least one known value associated with the transmitted PN sequence.

2. The method of claim 1, wherein the PN sequence comprises guard intervals for transmitted symbols.

3. The method of claim 1, wherein the PN sequence are known to a receiver.

4. The method of claim 1, wherein a mobile station (MS) receives signals using multiple antennas.

5. The method of claim 1, wherein a base station (BS) transmits signals using multiple antennas.

6. The method of claim 1, wherein the received power is associated with at least one BS.
